(19) United States
(12) Patent Application Publication
(10) Pub. No.: US 2021/0007188 A1
(43) Pub. Date: Jan. 7, 2021

(54) PORTABLE INDUCTION HEATER

(71) Applicant: Dynavap, LLC, DeForest, WI (US)

(72) Inventors: George R. Breiwa, III, Dane, WI (US); Robert Baddeley, Madison, WI (US)

(21) Appl. No.: 17/031,422

(22) Filed: Sep. 24, 2020

Related U.S. Application Data
(63) Continuation of application No. 16/768,223, filed on May 29, 2020.
(60) Provisional application No. 62/592,909, filed on Nov. 30, 2017.

(51) Int. Cl. H05B 6/10; H05B 6/04; H05B 6/06

(52) U.S. Cl. CPC H05B 6/108; H05B 6/06; H05B 6/04

(57) ABSTRACT

A portable induction heater is disclosed. In one construction, the portable induction heater is generally composed of a housing and a lid coupled to the housing. The lid has one or more apertures and a chamber coupled to at least one of the one or more apertures. The chamber is positioned in proximity to an induction heating element within the housing. A system for heating a hand held administration device is also disclosed.

### RELATED APPLICATIONS

This application claims priority to U.S. patent application Ser. No. 16/768,223, filed May 29, 2020, entitled PORTABLE INDUCTION HEATER; which is a national phase filing of International Application No. PCT/US2018/063421, filed Nov. 30, 2018, entitled PORTABLE INDUCTION HEATER; which claims the benefit of U.S. Provisional Patent Application No. 62/592,909, filed Nov. 30, 2017, entitled PORTABLE INDUCTION HEATER; the entire contents of each of which are hereby incorporated by reference herein in its entirety.

### FIELD

The present inventions relate to the field of induction heating devices. The present inventions more specifically relate to the field of portable induction heating devices.

### BACKGROUND

Two of the most significant challenges with current battery powered portable vaporizers or administration devices available today are battery capacity and general durability.

Both of these issues arise from the inherent space restrictions in a small device. By removing the two most problematic components from the hand held device, namely the power supply which heats the substance and the control circuitry for the device, the administration device can be miniaturized and constructed in a more durable fashion. To this end, placing the power supply and the control circuitry in a separate module would allow for improved capacity and improved durability. Thus, a need exists in the art for a portable induction heater which can be used with vaporizers and other administration devices.

### SUMMARY

Accordingly, a portable induction heater is provided. The portable induction heater disclosed herein introduces a simple way to quickly and easily heat a small and discreet induction compatible administration device to vaporization temperature. This is accomplished in a novel manner by utilizing a non-contact means of transferring the energy required to elevate the temperature of the extraction chamber of the administration device via an oscillating electromagnet field. Use of this device and method of heating allows for a complete separation and isolation of all or many of the electrical components from the extraction device. Moreover, isolation of the components facilitates simple measures to protect the sensitive electronic components from environmental perils.

In one or more examples of embodiments, a portable induction heater is disclosed which is generally composed of a housing and a lid coupled to the housing. The lid has one or more apertures and a chamber coupled to at least one of the one or more apertures. The chamber is positioned in proximity to an induction heating element within the housing. A lid toggle lever is rotatably coupled to the lid to cover and uncover at least one of the one or more apertures so as to provide access to the chamber positioned in proximity to the induction heating element within the housing.

An additional portable induction heater is disclosed comprising a housing and a lid removably secured to the housing, the lid having a lid toggle lever rotatable on the lid and configured to cover and uncover an aperture. An induction chamber is provided in the housing and aligned with the aperture. The induction chamber is configured to receive a portion of an administration device. An induction heating coil is positioned to heat the administration device when said device is positioned in the induction chamber. A microcontroller is in communication with the induction heating coil and in communication with a sensing device configured to detect the presence or absence of the administration device in the induction chamber. The induction heating coil is controllable by the microcontroller and a power source is arranged to deliver power on demand to one or more of the microcontroller, sensing device, and induction heating coil.

A system for heating a hand held administration device is also disclosed. The system includes a canister having a microcontroller therein. The microcontroller is in communication with and operably controls and powers an induction coil in response to a detected presence of the hand held administration device in the canister.

These and other features and advantages of devices, systems, and methods according to this invention are described in, or are apparent from, the following detailed descriptions of various examples of embodiments.

### BRIEF DESCRIPTION OF THE DRAWINGS

Various examples of embodiments of the systems, devices, and methods according to this invention will be described in detail, with reference to the following figures, wherein:

FIG. 1 is a perspective view of a portable induction heater according to one or more examples of embodiments.

FIG. 2 is an additional perspective view of the portable induction heater of FIG. 1.

FIG. 3 is an additional perspective view of the portable induction heater of FIG. 1, showing the lid with lid toggle lever rotated to provide access to the chambers.

FIG. 4 is a top perspective view of the lid of the portable induction heater of FIG. 1, showing the lid with lid toggle lever rotated as provided in FIG. 3.

FIG. 5 is a top perspective view of the lid of the portable induction heater of FIG. 4, showing the lid with lid toggle lever in the closed position.

FIG. 6 is a perspective view of a portable induction heater according to one or more alternative examples of embodiments, showing an alternative lid toggle lever in silhouette or at least partially transparent.

FIG. 7 is a perspective view of the portable induction heater shown in FIG. 6, showing the lid toggle lever in solid line, and showing an administration device at least partially inserted into a chamber.

FIG. 8 is a perspective view of the portable induction heater of FIGS. 1 & 6, showing the lid separated from the housing.

FIG. 9 is a perspective view of a lid with attached circuit board and showing the induction chamber and battery receptacle for one or more examples of a portable induction heater of FIGS. 1 & 6.

FIG. 10 is a perspective view of a lid with attached circuit board and showing the storage chamber for one or more examples of a portable induction heater of FIGS. 1 & 6.

FIG. 11 is a side elevation perspective view of the lid with attached circuit board shown in FIGS. 9 & 10.

FIG. 12 is a plan view of a first side of an example circuit board for use with one or more examples of a portable induction heater of FIGS. 1 & 6.

FIG. 13 is a plan view of a second side of an example circuit board for use with one or more examples of a portable induction heater of FIGS. 1 & 6.

FIG. 14 is a flow chart illustrating the intercommunication of a microcontroller and operational components of one or more examples of a portable induction heater as described herein and shown in FIGS. 1-13.

FIG. 15 is an example schematic circuit diagram according one or more examples of embodiments of the portable induction heater of FIGS. 1 & 6, showing representative examples of programmer, battery, 3.3V Reg., magnetic power switch, I2C pullups, microcontroller, induction heater, photocell, and LED output circuits.

FIG. 16 is an example schematic circuit diagram according one or more examples of embodiments of the portable induction heater of FIGS. 1 & 6, showing representative examples of a battery front end circuit.

FIG. 17 is an example schematic circuit diagram according one or more examples of embodiments of the portable induction heater of FIGS. 1 & 6, showing representative examples of USB PD controller and higher voltage charging circuits.

FIG. 18 is an alternative example schematic circuit diagram according one or more examples of embodiments of the portable induction heater of FIGS. 1 & 6, showing representative examples of a battery charger circuit.

FIG. 19 is an alternative example schematic circuit diagram according one or more examples of embodiments of the portable induction heater of FIGS. 1 & 6, showing representative examples of battery, magnetic power switch, and 3.3V Reg. circuits.

FIG. 20 is an alternative example schematic circuit diagram according one or more examples of embodiments of the portable induction heater of FIGS. 1 & 6, showing representative examples of boost converter, VBUS measurement, and fiducials circuits.

FIG. 21 is an alternative example schematic circuit diagram according one or more examples of embodiments of the portable induction heater of FIGS. 1 & 6, showing representative examples of administration device sensing (yap sense), microcontroller, programmer, LED output, and thermistor pullup circuits.

FIG. 22 is an alternative example schematic circuit diagram according one or more examples of embodiments of the portable induction heater of FIGS. 1 & 6, showing representative examples of output circuits.

FIG. 23 is an alternative example schematic circuit diagram according one or more examples of embodiments of the portable induction heater of FIGS. 1 & 6, showing representative examples of an induction heater circuit.

FIG. 24 is an alternative example schematic circuit diagram according one or more examples of embodiments of the portable induction heater of FIGS. 1 & 6, showing representative examples of a USB C waterproof connector circuit.

It should be understood that the drawings are not necessarily to scale. In certain instances, details that are not necessary to the understanding of the invention or render other details difficult to perceive may have been omitted. For ease of understanding and simplicity, common numbering of elements within the numerous illustrations is utilized when the element is the same in different Figures. It should be understood, of course, that the invention is not necessarily limited to the particular embodiments illustrated herein.

### DETAILED DESCRIPTION

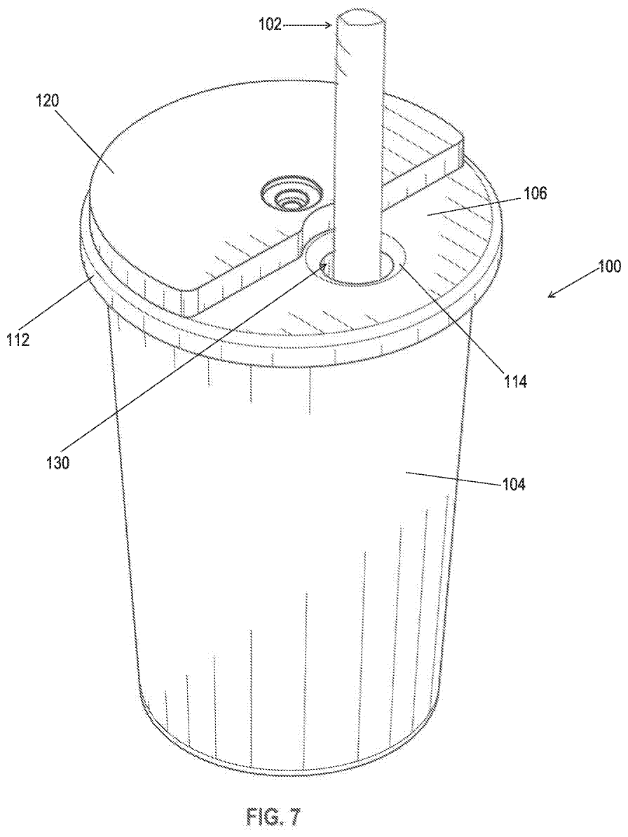

Referring to the Figures, a portable induction heater 100 is shown and described. According to one or more preferred examples of embodiments described herein, the portable induction heater 100 is a heating device for an administration device (such as but not limited to a vaporizer) that in a preferred embodiment uses induction to generate heat within the administration device. Generally, the portable induction heater 100 is comprised of a power supply connected to the appropriate circuitry for creating an oscillating electromagnetic field. This field is concentrated with an induction coil situated in a position to allow for easy heating of the administration device 102 (an example of which is shown in FIG. 7). Induction heating in the portable induction heater 100 is caused by a rapidly oscillating electric field in one or more coils of wire that generate(s) current in certain metals placed within the coil. Because the metal of the administration device 102 has electrical resistance, the current induced will generate heat. The heat is generated from within the metal being heated.

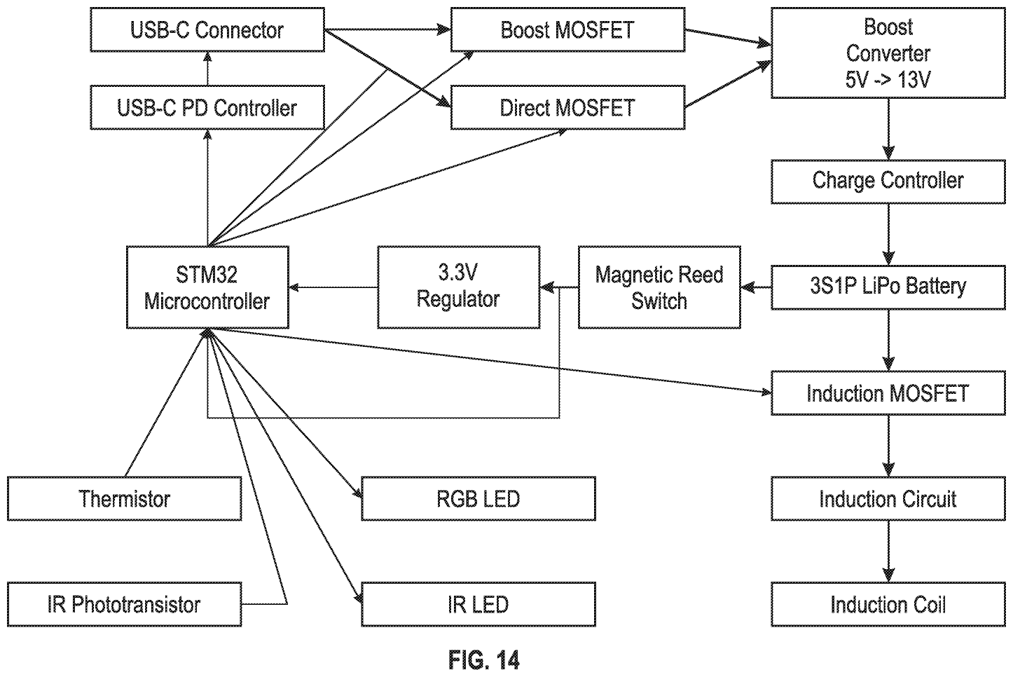

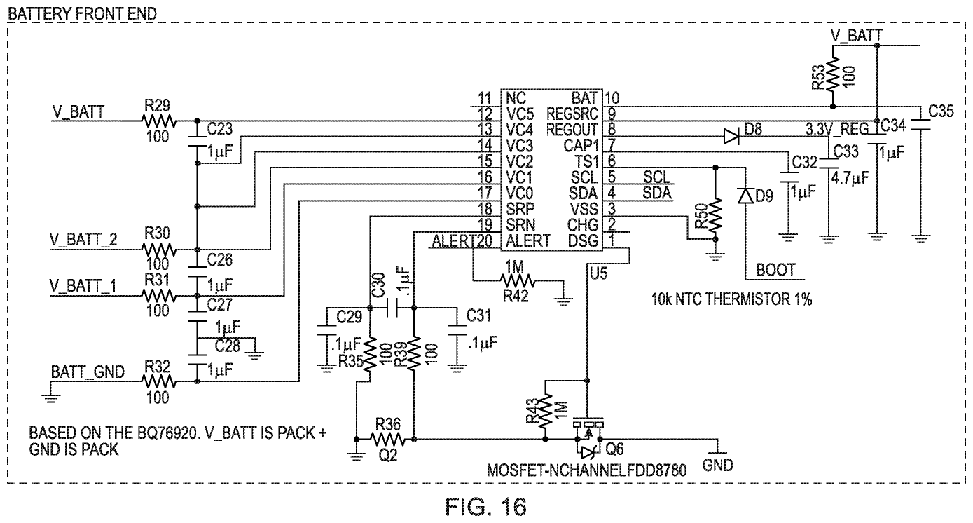

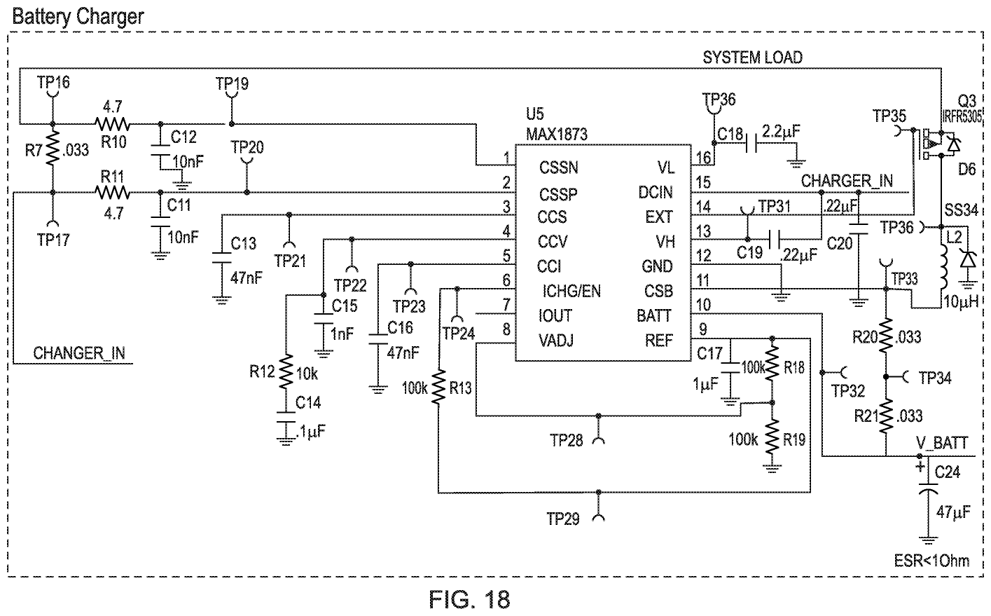

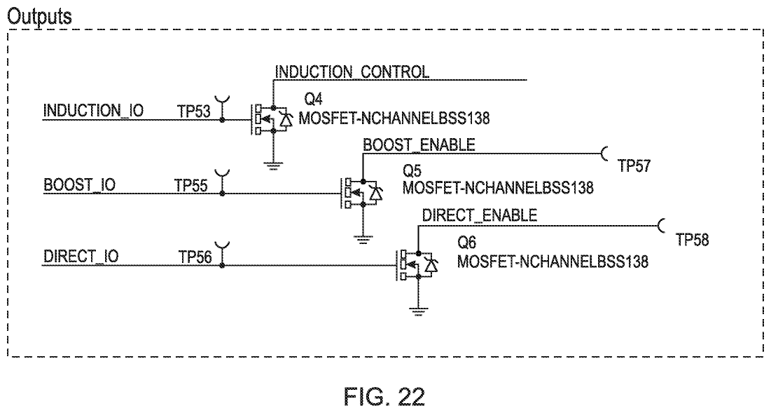

Various flow charts and circuit diagrams are provided herein to illustrate examples of the interconnection and operability of the components discussed and to provide one or more examples of suitable devices for accomplishing the identified task (see generally FIGS. 14-24). These flow charts and circuit diagrams are referenced generally in connection with the discussion of certain aspects of the portable induction heater described herein. It is understood that these are provided for purposes of illustration, and variations on these examples may be made without departing from the overall scope of the present invention.

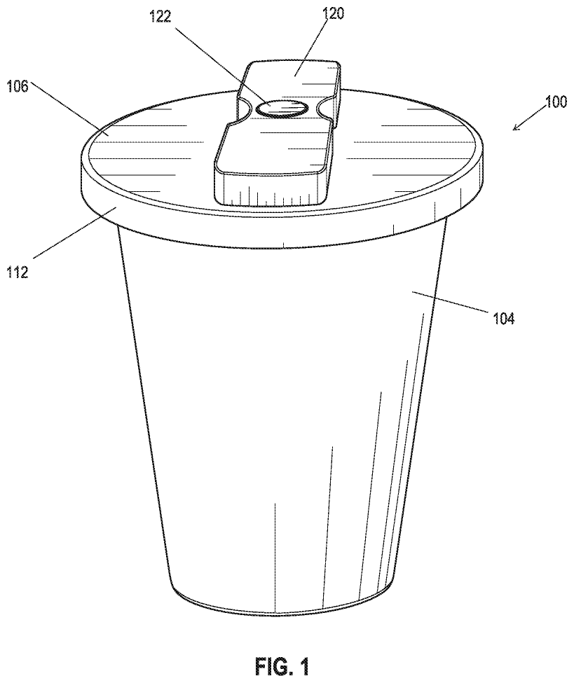

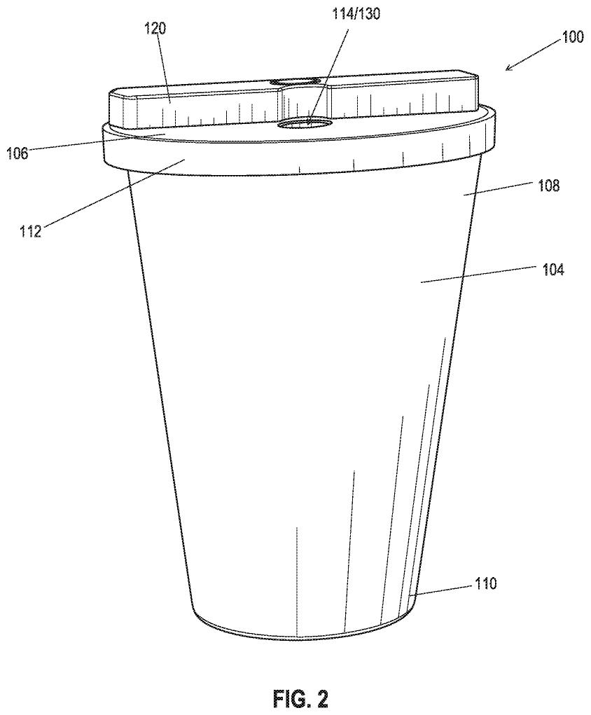

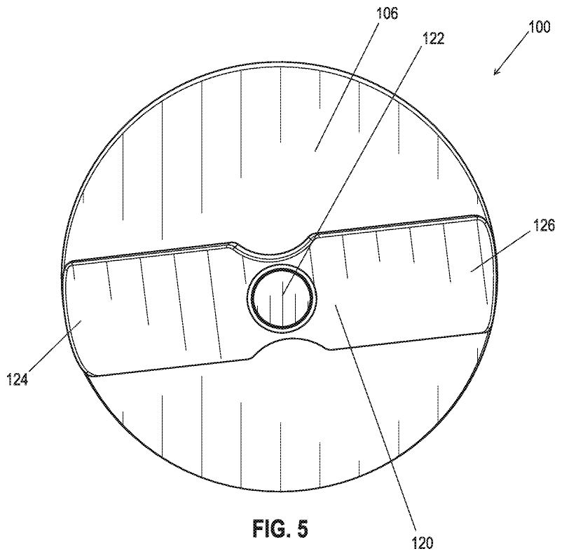

Referring to FIGS. 1-8, a portable induction heater 100 according to one or more examples of embodiments is shown. The portable induction heater 100 has a housing 104 or canister which surrounds the various operational components. A lid 106 may be seated on the housing 104, and in one or more embodiments is removably secured to the housing 104. In some embodiments, the lid 106 fits snuggly, is sealed, or is rigidly secured to the housing 104. More specifically, the housing 104 has a top 108 and a bottom 110. The lid 106 is secured to the top 108 of the housing 104, and in some examples of embodiments may be secured over the rim of the housing 104 with a snap fit. In the illustrated embodiment, the housing 104 is generally cylindrical in shape. More specifically, in some embodiments the housing 104 has a slight taper, similar to a cup. While a cylindrical-type shape and/or tapered cylindrical shape housing 104 or canister is specifically illustrated, it is contemplated that other geometric shapes may be suitable for the purposes of the portable induction heater described herein.

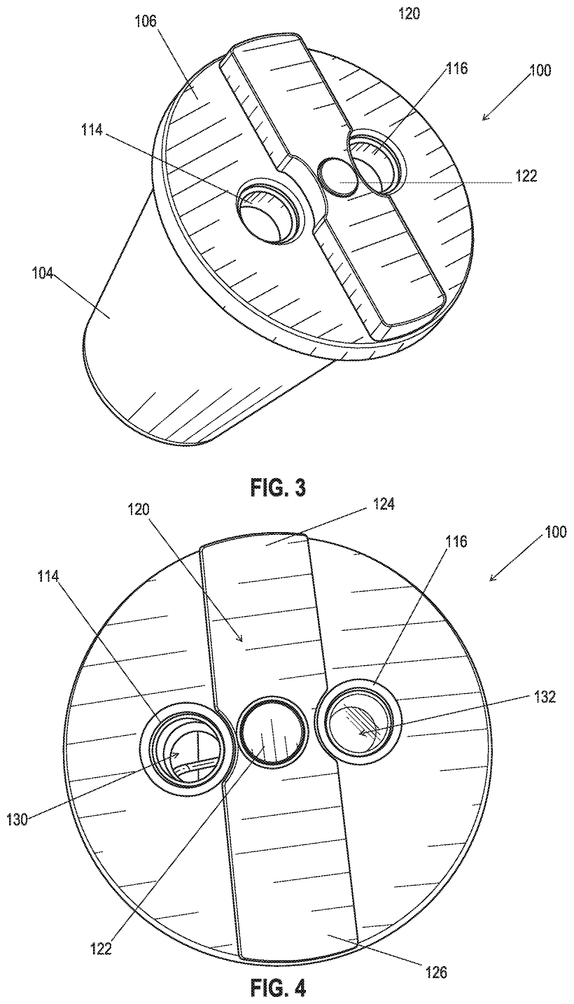

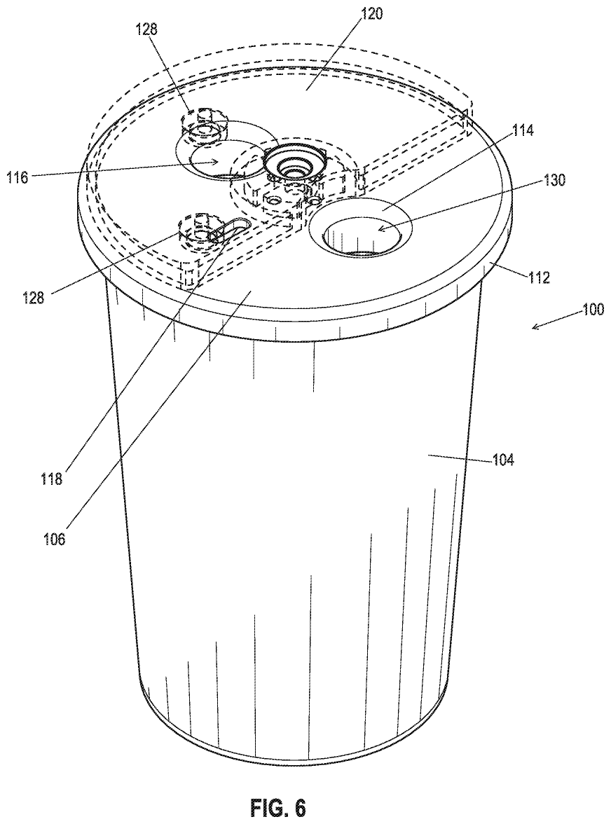

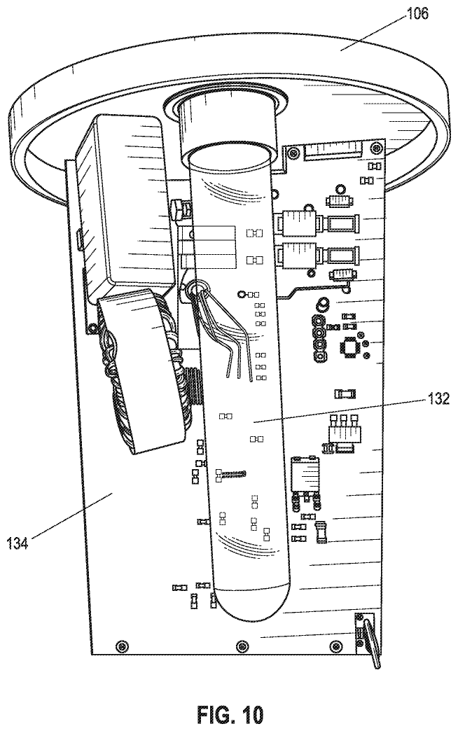

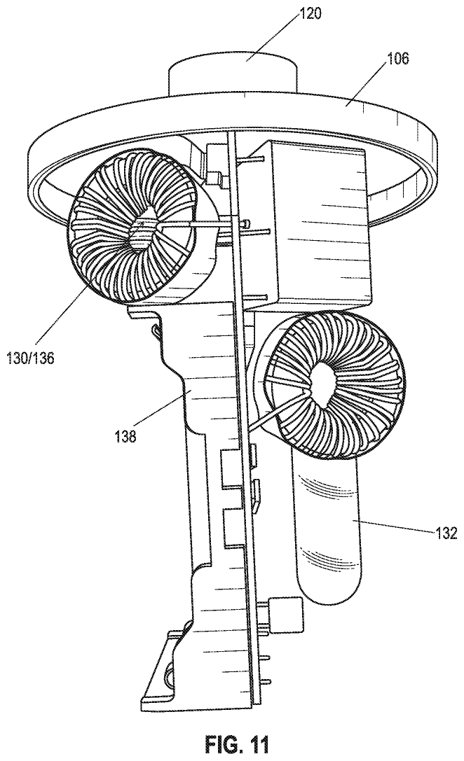

The lid 106 shown in FIGS. 1-11 is generally planar and has an outer lip or collar 112 which extends downward to permit securement to, or engagement with, the housing 104 or canister. In one example of embodiments, the lid 106, and in particular the collar 112 of the lid 106, engage the top 108 of the housing 104 or canister by friction fit, however, alternative means of connecting the elements, such as by mating threads or attachment devices or adhesives may also be acceptable. The lid 106 includes a plurality of apertures 114, 116. As can be seen in FIGS. 3-4, 6, first and second spaced apart apertures 114, 116 are shown in the lid 106. In the illustrated embodiment, the first and second apertures 114, 116 are on opposing sides of a center point of the circular lid 106. However, the apertures may be positioned in a variety of locations to accomplish the purposes provided herein. Additionally, while two apertures 114, 116 are shown, one aperture or more than one aperture (e.g., more than two) may be provided on the lid 106. To this end, in one or more additional examples of embodiments shown in FIG. 6, an additional aperture 118 is provided in the lid 106 for a USB-C (charging) connector (discussed in further detail hereinbelow).

Rotationally secured to the lid 106 is a lid toggle lever 120. The lid toggle lever 120 in the illustrated embodiment is secured by a pivot pin or rod 122 in the center of the lid 106. However, any location suitable for the purposes provided may be acceptable. The lid toggle lever 120 shown in FIG. 1 and FIGS. 3-5 has a first end 124 and a second end 126 which is opposite the first end. The lid toggle lever 120 also has a width which extends a dimension that is wider than the diameter or width of a lid aperture 114, 116 (and/or 118). In FIGS. 3-7, the lid toggle lever 120 shown has a first end 124 and second end 126 (see FIGS. 3-5) or segment (FIGS. 6-7) positioned such that the lid toggle lever 120 may be rotated about the pivot pin or rod 122 and positioned over one or both apertures 114, 116 on the lid 106. In FIGS. 6-7, the lid toggle lever 120 has a shape which corresponds to a segment of the lid shape, for example a wedge shape or approximate semi-circle. In other words, the lid toggle lever 120 covers a segment of the lid 106 and one or more apertures 114, 116, 118. The lid toggle lever 120 may also include one or more magnets 128 (see FIG. 6), and in a preferred embodiment at least two magnets. These magnets 128 are located/spaced in positions which, at certain orientations of the swivel of the lid toggle lever 120, position the magnet 128 above a magnetic reed switch (discussed in further detail below).

The housing 104, lid 106, and lid toggle lever 120 may be constructed of the same or similar material or may be constructed of different materials. In one or more examples of embodiments, a durable rigid or semi-rigid material, such as metal or plastic may be used for the housing 104 and/or lid 106 and/or lid toggle lever 120. Additionally, in one or more examples of embodiments, the material may be heat resistant. In other examples of embodiments, the material may not conduct heat, or may limit the transfer of heat. The housing 104 and lid 106 may be constructed or formed by means known in the art.

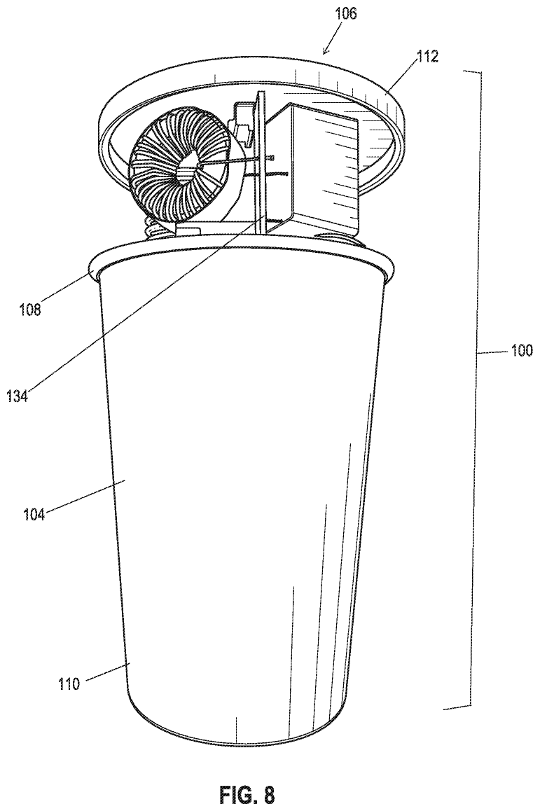

Referring to FIGS. 8-13, secured or attached below the lid 106 is a first chamber or shallow chamber 130, and a second chamber or deep chamber 132. The shallow chamber 130 has a length which is less than the deep chamber 132, and may be configured to receive a portion of an administration device 102. Each chamber 130, 132 may be a cylindrical shape having an open end aligned with an aperture 114 or 116 in the lid 106, and a closed end opposite the open end. While the cylinder is shown and described as having a cylindrical shape, alternative geometric shapes may be acceptable for the purposes provided. As indicated, each chamber 130, 132 may be open to and/or joined to an aperture 114 or 116 in the lid 106. In certain examples of embodiments, the deep chamber 132 may store an administration device 102 of the type described herein, and the shallow chamber 130 may be used for induction heating; to this end, the shallow chamber 130 may be an induction chamber and the deep chamber 132 may be a storage chamber. The storage chamber 132 may be configured or sized to receive an entire administration device 102 below the lid 106 and/or lid toggle lever 120. While specific dimensions and uses are described, variations thereon may be acceptable for the purposes provided. Likewise, while it is contemplated that the chambers 130, 132 may be joined to the lid 106 or joined to the circuit board or printed circuit board (PCB) retained within the housing 104, it is also contemplated that the chambers 130, 132 may be seated in the housing 104 or canister and aligned with the respective aperture(s) 114, 116 in the lid 106.

The first chamber 130 and the second chamber 132 may be constructed of any suitable material for the purposes provided. In one example of embodiments, one or both chambers 130, 132 may be composed of a clear or semi-transparent, heat resistant plastic or glass. However, the chambers 130, 132 may be constructed of other durable materials and in certain embodiments one or both chambers may also be opaque.

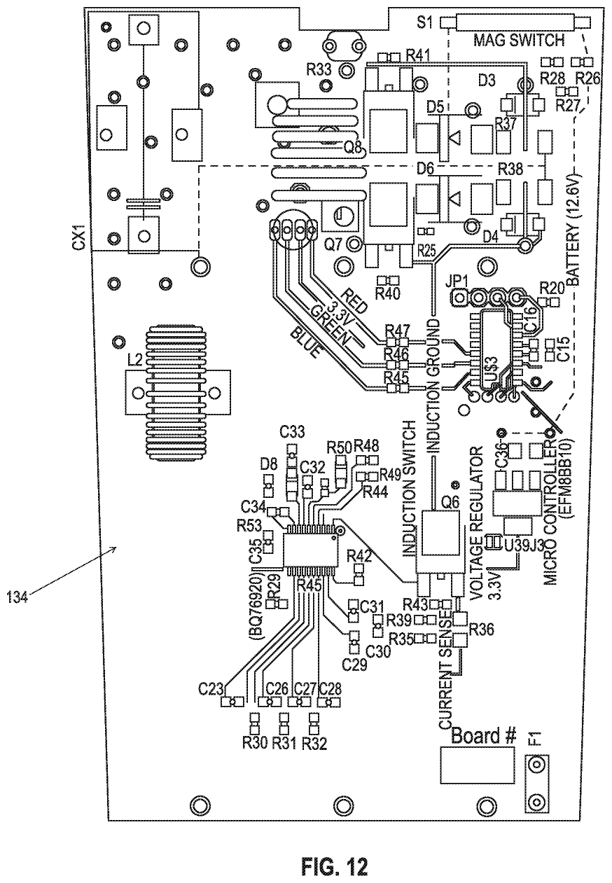

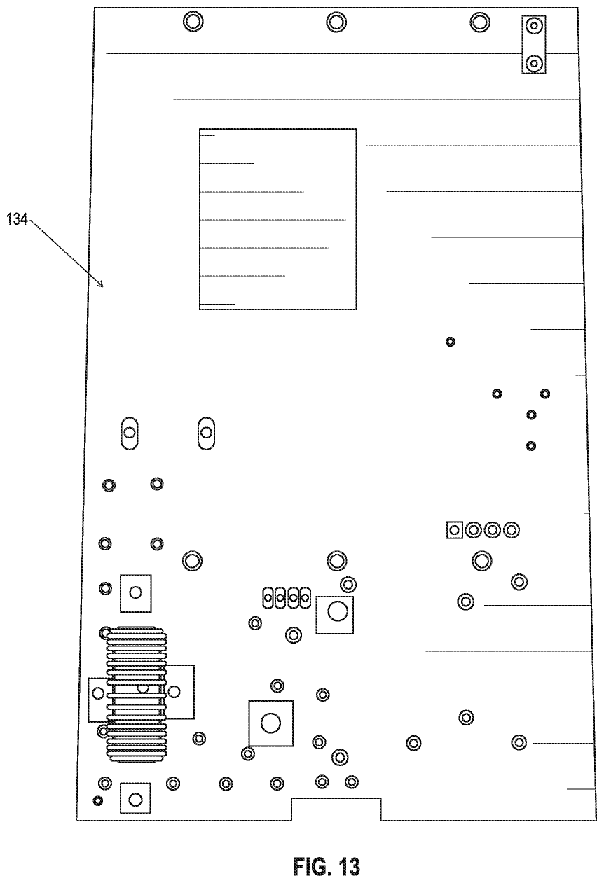

In one or more embodiments, a control or microcontroller and associated circuitry may be provided within the housing 104. As can be seen in FIGS. 12-13, a PCB 134 may be used which is designed to fit snugly inside the enclosure or housing 104 without additional supports, e.g., has a shape which corresponds to the shape of the housing 104. However, one of skill in the art would appreciate that one or more supports may be added without departing from the overall scope of the present invention. For example, a support may be included for shake or drop protection. The PCB 134 stands vertically with a USB connector coupled to lid aperture 118 at the top. The microcontroller or PCB 134 may be coupled to the lid 106 lower surface. To this end, the PCB 134 may optionally be retained in position by a retention device. In addition, small fins may extend down from the lid 106 to the PCB 134 to retain the PCB 134 in position in certain examples of embodiments. Alternative means of retaining the PCB 134 are also contemplated and one of skill in the art will appreciate that variations on the described retention mechanisms may be made without departing from the overall scope of the present invention.

As indicated, one or more induction heating elements or coils 136 may be provided, positioned within the housing 104 in proximity to or surrounding the induction chamber 130 which is arranged to hold the administration device 102, or arranged in another position to heat the administration device 102 inserted into the portable induction heater 100. In one or more preferred examples of embodiments the induction circuit is a Royer oscillator, although variations thereon may be acceptable for the purposes provided.

An indicator, such as a light, may be attached to the housing 104 or lid 106 or PCB 134. In one or more examples of embodiments, the indicator is a light attached within the housing 104 in a location such that it may be visible in one or both chambers 130, 132. In one or more examples of embodiments the light is an LED. In one or more further examples of embodiments, the LED is a RGB common anode device with, for example, three resistors for current limiting to adjust brightness. Variations thereon may also be acceptable. A phototransistor/emitter may also be provided. The phototransistor/emitter may be a pair of through-hole components which, first, emit IR light on one side of a chamber 130 or 132, and then, second, receive that light on the other side of the chamber 130 or 132—with blocked light indicating the presence of an object, such as an administration device 102, in the chamber.

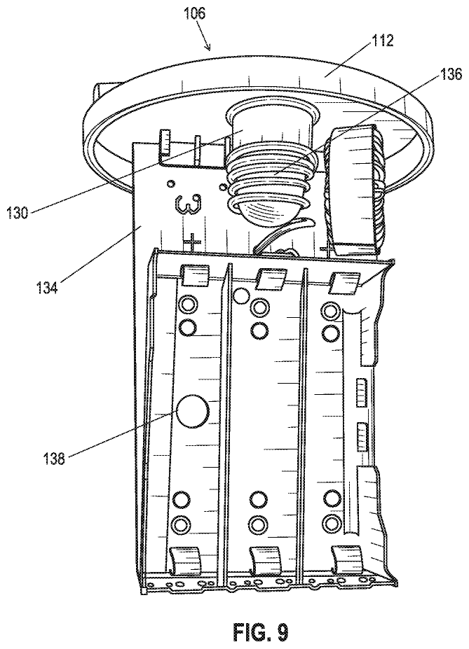

As indicated, a power source may be provided in or to the portable induction heater 100. The power source may be one or more batteries or rechargeable batteries, and to this end, the portable induction heater 100 or PCB 134 may have a battery receptacle 138 as shown in FIGS. 9, 11. In one or more examples of embodiments, power is supplied from an internal, rechargeable battery, such as but not limited to a lithium battery. In one or more additional examples of embodiments, the portable induction heater 100 may be used with one or more high-current batteries. While specific examples are provided, variations thereon may be acceptable. Likewise, while batteries are specifically described, it is contemplated that the portable induction heater 100 may be provided with an AC or DC power cord.

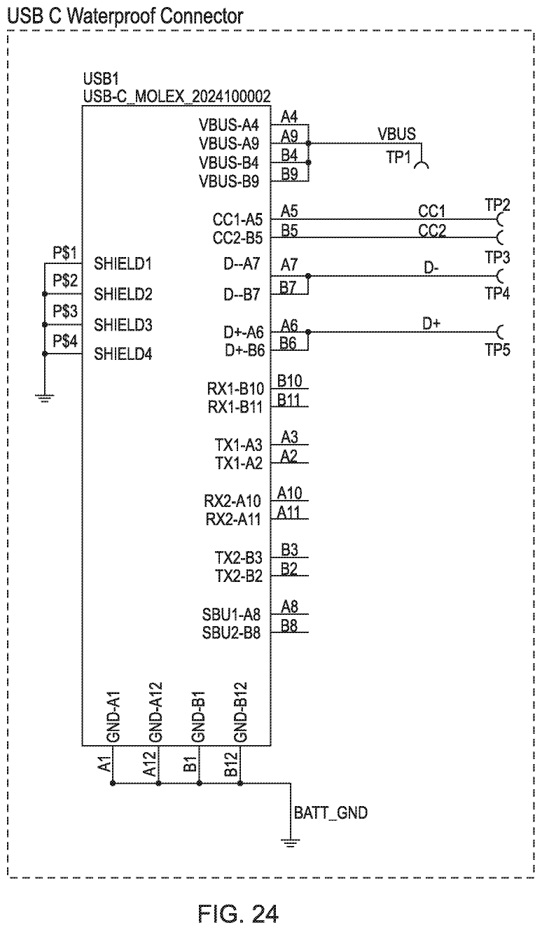

Appropriate charging and monitoring circuitry is in place, and a suitable connector is available on the housing 104 or lid 106 to allow charging of the internal battery. FIG. 6 shows an example of a connector aperture 118. A USB-C port may be provided joined to the aperture 118 and allows for charging. The connector may be included and retained, or hidden, under the lid 106 of the portable induction heater 100. As seen in FIG. 6, if/when the lid toggle lever 120 is rotated, the connector may be revealed and accessible. The portable induction heater 100 may therefore also be removably coupled to a power cord or other charging or power delivery device. In one or more preferred examples of embodiments, the USB-C is a waterproof connector (see FIG. 24).

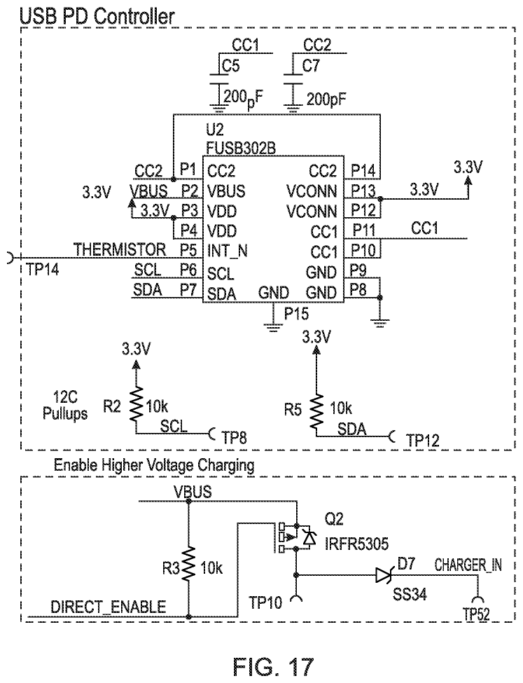

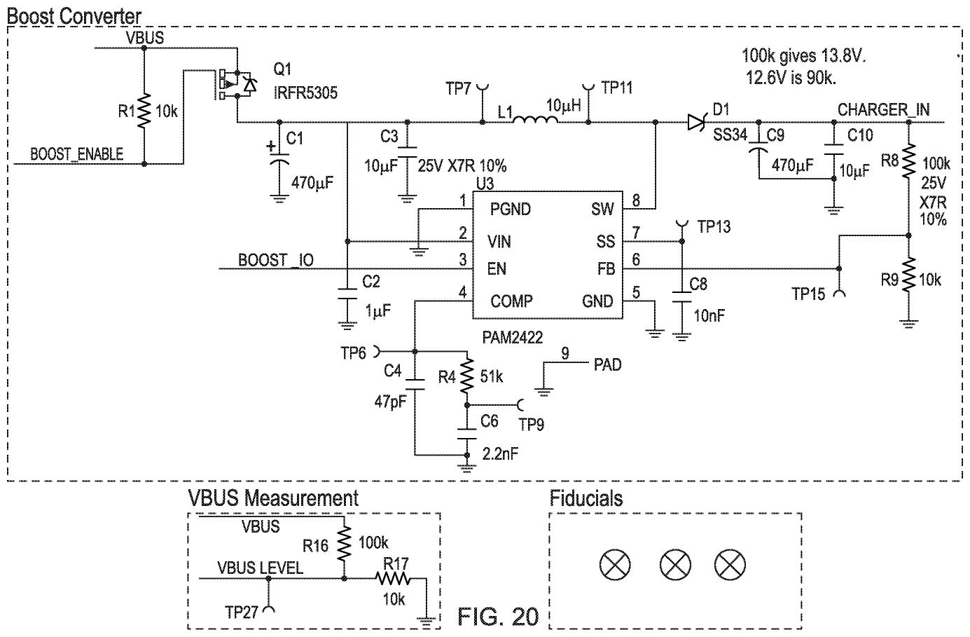

The power source may be configured to deliver power on demand to the portable induction heater 100 device. Power availability may be managed by a USB PD Controller (see FIG. 17), which negotiates with the USB source to obtain an appropriate amount of power, and may negotiate to maximize the possible power to increase the speed of charging. In one or more examples of embodiments, the USB source will only provide 5V, and up to 500 mA, but may permit up to 20V and 3 A in some embodiments. A boost converter may be provided (see FIG. 20) and used in one or more examples to increase the voltage when a weak supply or non-C power source is available. In some examples of embodiments, the boost converter may increase the voltage to 13.8V. One or more P-channel MOSFETs (Metal Oxide Semiconductor Field Effect Transistor(s)), called DIRECT ENABLE and BOOST ENABLE, may be provided to protect the boost converter from taking in more than its maximum input. As a result, voltage may be present between 12.6V and 20V at the CHARGER IN, which may be the input for the charge management chip, which in one or more examples of embodiments is a current-limited switch-mode lithium battery charger controller, and ensures that the battery is adequately and safely charged while maximizing its lifetime.

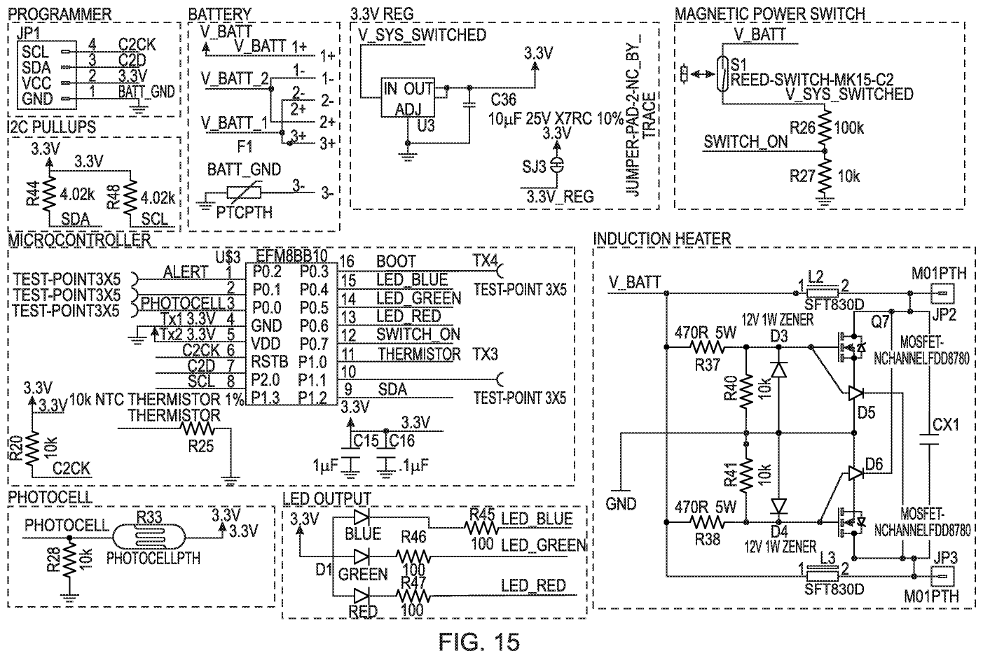

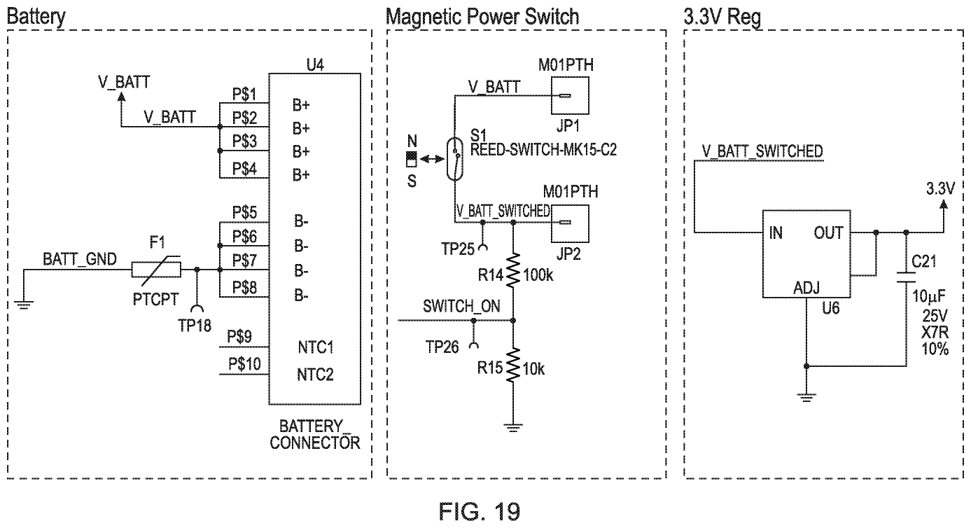

Referring to FIGS. 15, 19, according to one or more examples of embodiments, a magnetic reed switch is used to detect the enabling of the portable induction heater 100. In other words, a magnetic reed switch may be provided to enable/disable the portable induction heater 100. More specifically, one or more magnets 128 are provided within the lid toggle switch. When the lid toggle switch is rotated to a designated position, the magnet(s) 128 move and activate the magnetic reed switch. This enables the regulator (illustrated as a 3.3V regulator) and supplies power to the microcontroller and supporting circuitry and indicators. A voltage divider may also be provided to an input of the microcontroller to allow the microcontroller to determine whether the switch is on and the voltage level of the battery.

Referring again generally to FIGS. 14-24, in one or more examples of embodiments, operation of induction cannot occur while the unit is charging. For instance, in some examples of embodiments, to prevent simultaneous use and charging which could put undesirable stress on the power components, the swiveling lid toggle lever 120 or switch may be designed so that the charging port 118 and the induction port (e.g., 114 or 116) are not accessible at the same time. Moreover, according to one or more examples of embodiments, the batteries may be electrically protected by an internal overvoltage, undervoltage, and overcurrent protection circuit(s). To this end, a Battery Management System (BMS) may be provided. For example, a BMS may monitor the voltages of each battery cell and watch the current consumption of the portable induction heater 100. An indicator may also be provided which communicates the status of charge, such as, but not limited to a light or colored light or pulsed light (e.g., an LED). One or more additional safety devices may be incorporated into the portable induction heater 100, such as but not limited to, a thermal fuse, a thermistor, and/or monitoring of temperature by the microcontroller and response to certain thresholds. There may also be one or more temperature sensors in the portable induction heater 100. For example, two temperature sensors may be provided in the unit, one near the batteries and the other near the induction coil. These sensors may monitor the state of the unit and if the temperature rises above a certain threshold the sensors may operate to prevent the unit from working. Likewise, to prevent too much current from being drawn, a fuse may be installed to cut off power to the portable induction heater 100.

Referring to FIGS. 14-24, the microcontroller may be in communication with one or more sensors or other devices (described in further detail below) positioned to sense the presence or absence of an administration device 102 in a chamber 130 and/or 132 and/or one or more sensors or other devices positioned to sense the position of the lid toggle lever 120 and/or one or more sensors or other devices positioned to sense the temperature of the administration device 102 and/or portable induction heater 100. Moreover, the microcontroller may also be in communication with one or more heat sources. In particular, the microcontroller may be in communication with one or more induction heating coils. The microcontroller may also be in communication with one or more indicators to communicate various operations of the portable induction heating device. A timer may also be included in communication with the microcontroller in certain examples of embodiments.

As indicated and shown in FIGS. 14, 15, 21, among other figures, in one or more examples of embodiments the device may utilize an onboard microcontroller monitor the status of the system, to control outputs and/or activate certain components, and/or measure one or more attributes of the functioning device. These attributes may include, but are not limited to: monitoring the temperature of the power supply, monitoring the temperature of the induction coil, powering an indicator light, as well as permitting time out and over temperature functions which may be programmed/reprogrammed and executed depending on various parameters encountered or sensed by the portable induction heater 100 device. In one example of embodiments, the microcontroller may control the oscillation of the induction circuit through a gate driver. The microcontroller may also allow for periodic powering of a primary or secondary sensing induction coil to provide a means of determining if a suitable administration device 102 has been inserted into the coil for heating. In one example, this is accomplished by monitoring of the inductance of the coil when empty to create a reference value and comparing the reference value against subsequent inductance readings to determine if a conductive object such as an administration device 102 has been placed inside the coil 136, namely, inside the induction chamber 130. In another embodiment, a light source (e.g., either visible or infrared) on one side of the induction chamber 130, and a suitable sensor (photoresistor, photodiode, or phototransistor) on the other side of the induction chamber can be used to detect the presence of an inserted object in the induction chamber.

In one or more examples of embodiments, the microcontroller runs the charging power path, handles the interface, and runs the induction heating of the portable induction heater 100. As discussed, the microcontroller may be utilized through various electric control means to permit a variable frequency and/or variable amplitude oscillating electromagnetic field. These parameters may be adjusted by the microcontroller, which allows for a more effective transfer of thermal energy in a manner suited for achieving the desired extraction temperature and thermal saturation of the extraction chamber in, for example, an administration device 102 such as a vaporizer. Variable amplitude and frequency also permits effective usage of a variety of different conductive materials with similar and predictable results.

The microcontroller drives N-Channel MOSFETs, which control the P-Channel power MOSFET outputs for the induction and charge path. The microcontroller may communicate with the USB PD controller via I2C (a serial protocol for two-wire interface). This allows the microcontroller to determine when a portable induction heater 100 device is plugged in and ready to charge. The microcontroller also monitors the switch state through a voltage divider, and further, may control RGB LEDs. The microcontroller may also read the existence of an administration device 102 in the induction chamber 130 through a phototransistor, or by detecting a change in the voltage level of the switch when the induction heater is powered. The microcontroller controls the charging path, in one or more examples of embodiments, by allowing power to go into the charger directly, or through the boost converter and into the charger. As indicated, the microcontroller also controls induction. In one or more examples of embodiments, a single MOSFET from B_BATT to the induction is the only control. In alternative examples of embodiments, the microcontroller may provide pulse width modulation (PWM) to a pair of MOSFETS and control the oscillation directly. The microcontroller may also include a timer enabled to reboot the portable induction heater 100 in the event of a problem with the firmware causing the induction coils to remain “on”.

One or more examples of use of the portable induction heater 100 will now be described. It is understood that variations in steps, methods, and components may be acceptable without departing from the overall scope of the present invention.

To install the batteries, a user may remove the lid 106 from the canister. This may be accomplished by pulling the lid 106 straight up and off the canister 104. Batteries may then be inserted into their designated spots. The PCB 134 may then be placed back into the canister 104 with batteries in place. The portable induction heater 100 is then reassembled by placing the lid 106 onto the canister 104, and pressing down until the lid collar 112 snaps over canister rim or top 108. It is also noted that the batteries may be permanently installed in the portable induction heater 100, removing the need by the end user to open and change the batteries.

To turn on the portable induction heater 100, the lid toggle lever 120 may be rotated to expose a chamber 130 or 132, and in particular the induction chamber 130. The lid toggle lever 120 may be rotated exposing one or two chambers 130, 132. When the lid toggle lever 120 locks into place in the desired location for induction heating of an administration device 102, an indicator may activate. For example, the indicator may be a green light or LED which turns on in or near the induction chamber 130 and pulses. The indicator may signal to a user that the portable induction heater 100 is ready to heat.

At least a portion of the administration device 102 may now be inserted into the induction chamber 130. In one example, with cap down, a DynaVap® VapCap® (available from DynaVap, LLC, Madison, Wis.) may be placed into the induction chamber 130. An indicator may then deliver a signal indicating that the administration device 102 is heating. For example, an audible signal may sound or a light or LED may turn red and pulse, indicating it is heating.

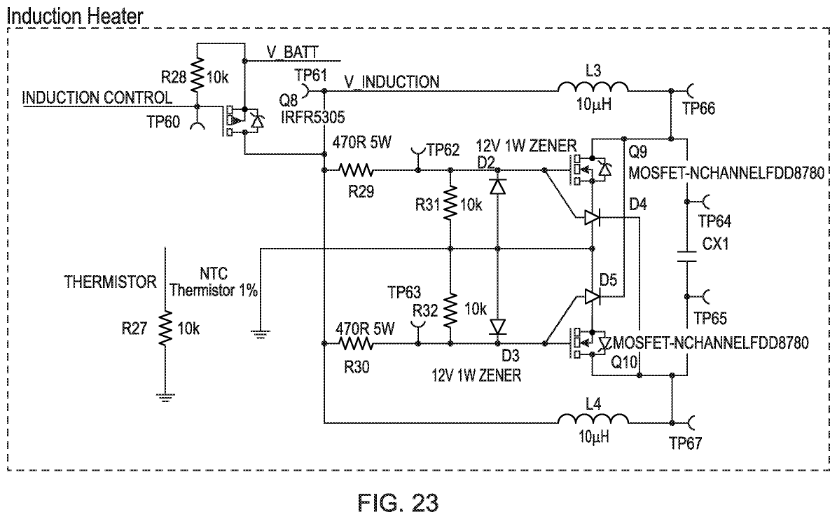

Referring to FIGS. 15, 23, the induction heater will be further discussed. The induction coil within the portable induction heater 100 may not always be powered on, for among other reasons, safety and power saving. Accordingly, in some examples of embodiments the coil(s) may be turned on, in some instances briefly, at regular intervals, and the current consumption measured. If the current consumption is below a certain level, then a decision is made by the microcontroller that the device is not inducing current in a metal object and is therefore not in use and so powers off. On the other hand, if current consumption is above the threshold, a decision is made by the microcontroller that an administration device 102 is present in the induction chamber 130 and a heating cycle takes place until it times out, or removal of the device is detected (e.g., by monitoring and detecting a significant change in battery voltage) and the heating cycle is interrupted, or some other event occurs which terminates the cycle. In one or more alternative embodiments, a wavelength of light may be monitored-which wavelength may optionally be narrow, for example a specific wavelength or range of wavelengths—to detect the presence or absence of an administration device 102 in an induction chamber 130. For instance, an infrared (IR) transmitter and an IR receiver (phototransistor) placed on opposite sides of the induction chamber 130 may be used to monitor/detect the insertion or removal of an administration device 102. In some examples, the IR transmitter may be occasionally turned on and if the level measured is outside of a threshold, a change is assumed. In other examples, the presence of an administration device 102 may block some or all of the generated IR light to the phototransistor, which then signals the microcontroller to turn on the induction coil(s) 136. The phototransistor can also be monitored to determine when the administration device 102 has been removed, that is, a change or increase in IR light is detected by the phototransistor. Current may also be measured to determine whether a metal device has been inserted into the induction chamber 130, and the microcontroller may disable the device if the detected current is outside an expected or pre-programmed current range.

In one or more preferred examples of embodiments, induction mode may include multiple sub-states. When first powered on, ifVBUS (e.g., a USB wire carrying a power) is 0, then it is assumed that induction will occur. An indicator may activate (e.g., an LED turns green) to indicate the portable induction heater 100 is ready for operation. The IR light or LED may be powered and readings taken from the phototransistor to capture a baseline level, in order to detect insertion of a device. The charging MOSFETs may be disabled at this time. In this state, the portable induction heater 100, and in particular the microcontroller, waits and continues to take readings. If the battery voltage drops below a threshold, the device may switch to an error state indicating low battery. When the phototransistor reading crosses a threshold, indicating that the IR beam has been interrupted, then the microcontroller may enable the induction MOSFET, and the indicator generates a signal (e.g., the LED turns red). The microcontroller may then continue to monitor the battery voltage and the phototransistor to detect rapid changes. If the phototransistor value suddenly changes, this indicates a change in the light levels caused by removal of the administration device 102, and the microcontroller in response halts induction (powers down). Similarly, if the voltage suddenly rises, this signals that induction is no longer occurring in the administration device 102, and the microcontroller may halt induction. Additionally, after a period of time, induction is automatically turned off

If any of the foregoing shut down procedures occur, the portable induction heater 100 may transition from heating to lockout. In one or more examples of embodiments, lockout may be a period of time where use of the device is not permitted, allowing the device to cool if necessary. The lockout period may be related to the induction period, so that brief use may result in a brief lockout. An indicator may activate to signal lockout (e.g., an LED turns yellow). Once the lockout period is complete, if no administration device 102 is detected, the portable induction heater 100 may return to a waiting state and an indicator may identify this status (e.g., an LED turns green). The IR baseline values may be recalibrated at this time. If an administration device 102 is detected, the portable induction heater 100 may remain in lockout mode until the device is removed from the chamber 130.

In one or more examples of embodiments, the portable induction heater 100 may also comprise a low power state, which is activated following a period of non-use. In low power state, the unit may be configured to consume the least amount of power possible.

When induction heating is complete or the desired temperature is reached, the administration device 102 may then be removed from the induction chamber 130. In some embodiments, the desired temperature may be communicated to the user by the administration device 102. In other embodiments, the portable induction heater 100 may communicate to the user that the desired temperature has been reached by use of an indicator. For example, the light on the portable induction heater 100 may turn yellow to indicate a completed cycle. In some examples of embodiments, the indicator may remain active, e.g., the light may stay yellow, until the chamber 130 and/or portable induction heater 100 cools. The portable induction heater 100 may then indicate when it has returned to its original or “ready” temperature. For example, the light may turn to green and pulse. While automated means of communicating a desired temperature are described, it is also contemplated that the user may remove the administration device 102 from the chamber 130 of the portable induction heater 100 at any time.

Once the administration device 102 is removed, to turn off the induction heater, a user may rotate the lid toggle lever 120 back to cover the chamber(s) 130, 132.

In order to use a storage chamber 132, the lid toggle lever 120 may be rotated to reveal the corresponding aperture 114 or 116 in the lid 106. The administration device 102 may then be inserted into the storage chamber 132 and lid toggle lever 120 rotated to cover the aperture 114 or 116.

Referring to FIGS. 15-19 battery charging will be further discussed. When in charging mode, the delivered voltage (VBUS) is monitored. The microcontroller may communicate with a USB Power Delivery chip over I2C to negotiate the appropriate power level in a manner described above. The microcontroller may then monitor VBUS and wait for the detection of an appropriate voltage, e.g., 5V, 9V, 15V, 20V. Once at the expected voltage, the microcontroller may enable the MOSFET for either DIRECT ENABLE (if 15V or 20V) or BOOST ENABLE (if 5V or 9V). In addition, the microcontroller may monitor the battery voltage to verify that it is the expected voltage and not above or below safe levels for the battery. An indicator may also signal the mode, e.g. charging, of the device and/or status of charging (e.g. completion). During charging, the infrared light may be off.

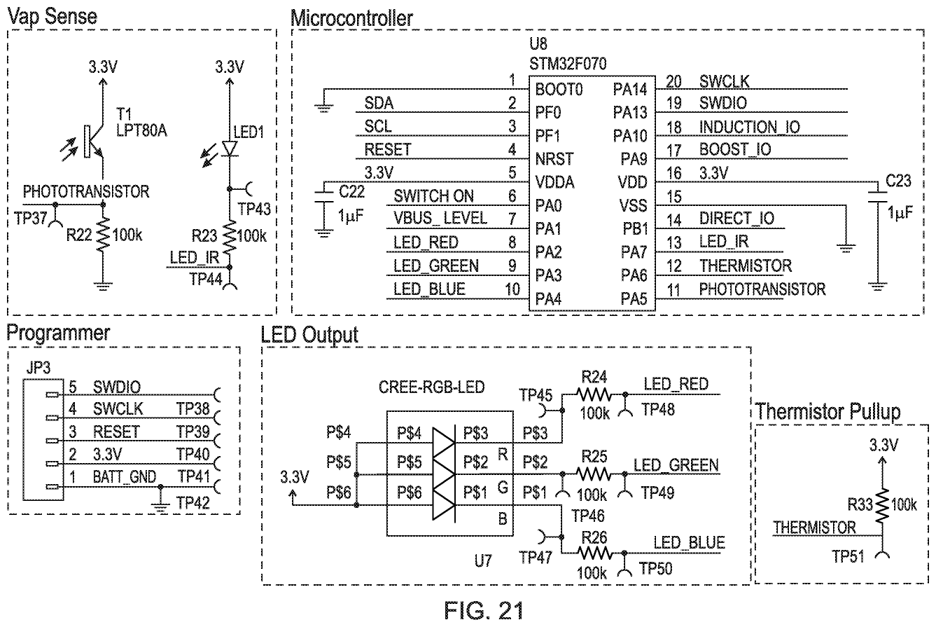

In the description above, various examples of lights or LEDs are described which are provided as status indicators. See also FIGS. 15, 21. Example indicator lights and associated meanings of these lights are shown in the chart below for purposes of illustration only. One of skill in the art would understand that any suitable light or indicator, e.g., audible, tactile, and the like, may be used in place of the examples provided.

TABLE 1
Example Indicator Lights

| Color/Indicator | Meaning | Explanation |
|---|---|---|
| off | Off | The system is old or the batteries may |
| | | not be installed. |
| Green Pulse | Ready | The unit is waiting for insertion of an |
| | | administration device. |
| Red Pulse | Heating | The induction heater is running and heating |
| | | the administration device. |
| Yellow | Complete/ | The administration device is done heating |
| | Lockout | and the portable induction heater is now |
| | | in a cool-down period. It will stay in |
| | | this state until the device is removed and |
| | | the cool-down period is over, or until the |
| | | internal temperature sensors are below a |
| | | safe threshold. |
| Flashing | Error | An unknown error. Close the cover and |
| White | | re-open, or remove the batteries and |
| | | re-insert. |
| Flashing | Low | The batteries have discharged too much. |
| Blue | Battery | They will need to be recharged. |

Advantageously, the portable induction heater uses induction to heat up an administration device. Metal is often used for an administration device or vaporizer which has electrical resistance. The heat is generated from within the metal being heated, and to this end, only conductive metals may be affected by being placed inside of the induction chamber. Consequently, the current induced by the coil(s) of the portable induction heater will generate heat at the administration device. Anything else, however, will experience no heating at all. It also means there is no open flame or resistive heating element. Advantageously, heating of an administration device is safe, fast, does not require an open flame, and can be operated with a single hand. It also allows for improved capacity and improved durability. Moreover, by removing the two most problematic components from the administration device, namely the power supply which heats the substance and the control circuitry for the device, and placing them in the portable induction heater, the administration device can be miniaturized and constructed in a more durable fashion.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

What is claimed is:

1. A portable induction heater for inductively heating an administration device, the portable induction heater comprising:
an enclosure having an aperture to receive the administration device;
a chamber coupled to the aperture, the chamber having an open end, a closed end opposite the open end, and a wall between the open end and the closed end, the open end of the chamber coinciding with the aperture of the enclosure, the chamber to receive a portion of the administration device;
an induction heating device within the enclosure and in close proximity to the chamber;
a power supply; and
a controller electrically connected to the power supply and to the induction heating device, the controller being configured to controllably provide power to the induction heating device to inductively heat the administration device when received by the chamber.

2. The portable induction heater of claim 1, wherein the controller further includes a microcontroller.

3. The portable induction heater of claim 1, and further comprising an indicator within or on the enclosure and coupled to the controller, wherein the controller is further configured to control the indicator to signal one or more operational states of the portable induction heater.

4. The portable induction heater of claim 3, wherein the indicator is a light source, and wherein the controller is further configured to provide power to the light source to emit a light having a relation to the administration device being received by the chamber.

5. The portable induction heater of claim 3, wherein the indicator is a light source, and wherein the controller is further configured to provide power to the light source to emit a light having a relation to the controller providing power to the induction heating device.

6. The portable induction heater of claim 3, wherein the power supply includes a battery, wherein the indicator is a light source, and wherein the controller is further configured to provide power to the light source to emit a light having a relation to a state of the battery.

7. The portable induction heater of claim 1, wherein the induction heating device includes an induction heating coil, and wherein at least a portion of the coil is disposed around the wall of the chamber.

8. The portable induction heater of claim 7, wherein the controller being configured to controllably provide power to the induction heating coil includes providing a variable current to the induction heating coil.

9. The portable induction heater of claim 7, wherein the controller includes one or more switches, and wherein the controller being configured to controllably provide power to the induction heating device includes the controller being further configured to:
sense when the portion of the administration device is received by the chamber; and
control the one or more switches to provide a variable current to the induction heating coil when the portion of the administration device is sensed.

10. The portable induction heater of claim 9, wherein the controller being configured to sense when the portion of the administration device is received by the chamber includes the controller being further configured to:
periodically powering the induction heating coil; and
monitoring a response of the induction heating coil after powering the induction heating coil.

11. The portable induction heater of claim 9, wherein the controller being configured to controllably provide power to the induction heating device includes the controller being further configured to:
sense when the portion of the administration device is removed from the chamber; and
control the one or more switches to no longer provide the variable current to the induction heating coil when the portion of the administration device is removed from the chamber.

12. The portable induction heater of claim 9, further comprising a temperature sensor within or on the enclosure, in close proximity to the chamber, and coupled to the controller, and wherein the controller being configured to controllably provide power to the induction heating device includes the controller being further configured to:
monitor the temperature sensor to determine a temperature; and
control the one or more switches to no longer provide the variable current to the induction heating coil when the temperature traverses a value.

13. The portable induction heater of claim 9, wherein the controller being configured to controllably provide power to the induction heating device includes the controller being further configured to control the one or more switches to no longer provide the variable current to the induction heating coil after a set time period.

14. A portable induction heater for inductively heating an administration device, the portable induction heater comprising:
an enclosure having an aperture to receive the administration device;
a chamber coupled to the aperture, the chamber having an open end, a closed end opposite the open end, and a wall between the open end and the closed end, the open end of the chamber coinciding with the aperture of the enclosure, the chamber to receive a portion of the administration device;
an induction heating coil within the enclosure, and at least a portion of the coil is disposed around the wall of the chamber;
a power supply; and
a controller comprising a microcontroller and one or more switches electrically connected to the microcontroller and between the power supply and the induction heating coil, the microcontroller being configured to control the one or more switches to provide a variable current to the induction heating coil for inductively heating the administration device when received by the chamber.

15. The portable induction heater of claim 14, and further comprising an indicator within or on the enclosure and coupled to the microcontroller, wherein the microcontroller is further configured to control the indicator to signal one or more operational states of the portable induction heater.

16. The portable induction heater of claim 15, wherein the indicator is a light source, and wherein the microcontroller is further configured to control power to the light source to emit a light having a relation to the administration device being received by the chamber.

17. The portable induction heater of claim 15, wherein the power source includes a battery, wherein the indicator is a light source, and wherein the microcontroller is further configured to control power to the light source to emit a light having a relation to a state of the battery.

18. The portable induction heater of claim 14, wherein the microcontroller is further configured to:
periodically powering the induction heating coil; and
monitoring a response of the induction heating coil after powering the induction heating coil.

19. The portable induction heater of claim 18, wherein the microcontroller being configured to controllably provide power to the induction heating coil comprises the microcontroller being further configured to:
sense when the portion of the administration device is removed from the chamber; and
control the one or more switches to no longer provide the variable current to the induction heating coil when the portion of the administration device is removed from the chamber.
